(19) United States
(12) Patent Application Publication
(10) Pub. No.: US 2025/0053933 A1
(43) Pub. Date: Feb. 13, 2025

(54) ASYNCHRONOUS MEETING PARTICIPATION

(71) Applicant: Microsoft Technology Licensing, LLC, Redmond, WA (US)

(72) Inventors: Zongzhen CHUA, Seattle, WA (US); Giovanni de Medeiros BASSO, Campinas (BR); Rogea Rocha SILVEIRA, London (GB); Roberto Ribeiro da Fonseca MENDES, Seattle, WA (US); Jori DE GROOT, Snohomish, WA (US); Berenice Maria CONTRERAS HERNANDEZ, Cancun (MX); Christa KEIZER, Redmond, WA (US); Rachelle Ellen TOBKES, Pembroke Pines, FL (US); Ralph Georges MAAMARI, Toronto (CA)

(21) Appl. No.: 18/448,786

(22) Filed: Aug. 11, 2023

(51) Int. Cl. G06Q 10/1093

(52) U.S. Cl. CPC G06Q 10/1095

(57) ABSTRACT

The present disclosure describes an asynchronous meeting system that provides a framework for users to participate asynchronously in virtual meetings. The asynchronous meeting system enables seamless interaction between multiple applications, allowing participants to engage before, during, and after meetings. Additionally, the asynchronous meeting system offers various features and tools for users to communicate their intention of being an asynchronous meeting participant (e.g., a non-attending meeting participant) to the meeting organizer and other attendees. Furthermore, the asynchronous meeting system provides asynchronous participants access to the meeting and its resources, including agendas, notes, in-meeting communications, recordings, and summaries.

### BACKGROUND

Recent years have witnessed a significant increase in both hardware and software advancements related to virtual meetings. Factors such as remote work, hybrid work models, flexible scheduling, and global locations have contributed to the growing number of virtual meetings. The increased frequency of these virtual meetings, however, has led to an increase in meeting conflicts, resulting in various technical computer problems. One such issue is the lack of efficient solutions in existing systems that allow users to participate in virtual meetings when they are unable to attend the meeting. Currently, when a user declines a meeting invitation, their access to the meeting is typically cut off, limiting access to meeting resources before, during, and after the meeting. On the other hand, indicating possible attendance can confuse meeting organizers and other participants and otherwise create frustration among meeting participants and create unnecessary tasks for the parties involved. These and other technical limitations exist in conventional products that provide virtual meeting services, particularly in connection with non-attending virtual meeting participants.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an overview example of implementing an asynchronous meeting system that enables users to participate in virtual meetings without attending the meetings.

FIG. 2A illustrates a block diagram of an example computing device that implements an asynchronous meeting system.

FIG. 2B illustrates a computer network environment where an asynchronous meeting system is implemented.

FIG. 3 illustrates a sequence flow diagram enabling asynchronous participation in virtual meetings.

FIGS. 4A-4D illustrate a sequence of graphical user interfaces to facilitate asynchronous participation in a virtual meeting.

FIG. 5 illustrates a graphical user interface example of a meeting organizer viewing meeting participants including an asynchronous participant.

FIG. 6 illustrates a graphical user interface example of an example virtual meeting that includes an asynchronous participant.

FIG. 7 illustrates a graphical user interface example of a user communicating asynchronous participation in a virtual meeting to a third-party system.

FIGS. 8 and 9 each illustrate a series of acts of a computer-implemented method for implementing asynchronous user participation across multiple computer applications.

FIG. 10 illustrates components included within an example computer system.

### DETAILED DESCRIPTION

The present disclosure describes an asynchronous meeting system that efficiently, accurately, and flexibly enables users to asynchronously participate in virtual meetings. In various instances, the asynchronous meeting system provides a framework that enables seamless interaction between multiple applications to allow asynchronous participants in virtual meetings before, during, and after meetings. Additionally, the asynchronous meeting system provides various features and tools that, with minimal user action, allow a user to communicate their intention to be an asynchronous meeting participant (e.g., a non-attending meeting participant) to the meeting organizer and other attendees. Further, the asynchronous meeting system provides an asynchronous participant with access to the meeting and meeting resources, such as agendas, notes, in-meeting communications, meeting recordings, and meeting summaries.

To illustrate from the perspective of an asynchronous participant (or simply “async participant”), in one or more implementations, upon a user receiving a virtual meeting invite in the form of a calendar event invite, the asynchronous meeting system determines to provide an async participant option within the calendar event invite. In response to detecting a selection of the async participant option, the asynchronous meeting system provides a reply to the meeting organizer indicating the user as an async participant of the virtual meeting. Additionally, the asynchronous meeting system generates a visually-distinct calendar event for the user that indicates asynchronous participation in the virtual meeting. Further, the asynchronous meeting system provides the user with access to meeting resources. For instance, the asynchronous meeting system notifies the user after the virtual meeting when various resources from the virtual meeting are available.

To illustrate from the perspective of the meeting organizer, in various implementations, the meeting organizer generates a calendar event invite for a virtual meeting that includes inviting multiple participants, such as the user mentioned in the above paragraph. In response to sending out the calendar event invite, the meeting organizer receives a reply to the calendar event invite indicating the user as an async participant. Based on the reply, the asynchronous meeting system modifies the calendar event for the virtual meeting to indicate the user as an async participant. During the meeting, the asynchronous meeting system provides an indication to the meeting organizer for actions to occur during the virtual meeting to accommodate the async participant. Further, the asynchronous meeting system displays the async participant within the virtual meeting as not attending the virtual meeting but having access to meeting resources.

As described in the following paragraphs as well as throughout this document, the asynchronous meeting system delivers several significant technical benefits in terms of computing efficiency, flexibility, and accuracy compared to existing systems. Moreover, the asynchronous meeting system provides several practical applications that address problems relating to implementing asynchronous user participation across multiple computer applications.

To better understand the technical benefits of the asynchronous meeting system, additional context regarding the shortcomings of existing systems will first be discussed. For example, to allow for a meeting to have async participants, many existing systems require multiple users to perform multiple actions. For instance, when a user receives a virtual meeting invite, they first check to see whether the meeting conflicts with another event. If the user cannot attend, they decline the invite or select a possible attendance option. If the user declines the invite, their access to the meeting and meeting resources is cut off. Even if the user tentatively accepts the invite, some systems still do not grant access.

Additionally, if the user would like to stay involved, they typically need to send a follow-up message to the meeting organizer indicating this intention. This often involves the meeting organizer to perform additional actions before, during, and/or after the meeting to accommodate to the tentative request. For example, in addition to conducting the meeting, the meeting organizer would need to remember or create a note to memorialize the meeting. Additionally, the meeting organizer would need to manually provide a meeting summary and/or other meeting resources to async participants. Further, these actions often need to be performed across different applications, which use different user data sets that must be frequently coordinated.

Conversely, as mentioned above, the asynchronous meeting system provides an automatic framework for implementing asynchronous meeting participants (or “async participants” for short). For example, the asynchronous meeting system provides features and tools that seamlessly enable async participation for meeting organizers, in-meeting participants, and async participants. Further, the asynchronous meeting system provides these features and tools before, during, and after virtual meetings as well as across multiple applications, when applicable.

To elaborate, by utilizing data objects shared between applications, the asynchronous meeting system improves efficiency, accuracy, and flexibility. For example, the asynchronous meeting system maintains a calendar event object for a virtual meeting that includes one or more attributes or sub-objects associated with a virtual meeting, invited participants, their attendance status, and access to meeting resources. Based on the calendar event object indicating an async participant, one or more applications automatically perform various actions (further discussed below) before, during, and after the meeting. Further, the shared data results in improved efficiency in accessing and storing meeting data as well as improved accuracy and interaction through sharing the meeting data source.

Additionally, by allowing async participants access to the meeting and meeting resources, the asynchronous meeting system improves efficiency and flexibility over existing systems. For example, upon indicating being an async participant, a user is not cut off from meeting resources. Rather, the asynchronous meeting system provides the user with access to the same resources as other meeting participants. This access extends from before the meeting to after the meeting, allowing the async participant to follow up and share meeting insights with other participants after the meeting has ended.

Additionally, the asynchronous meeting system automatically provides various features that enable async participants to be more involved with the meeting resources, such as notifying the async participant when various meeting resources become available. Further, the asynchronous meeting system triggers the creation of one or more meeting resources to be provided to the async participant that, in some instances, would otherwise not be created, such as initiating a meeting recording and/or a meeting summary.

In addition, by selectively providing an async participant option in a calendar event for a virtual meeting, the asynchronous meeting system efficiently and seamlessly signals a user's intent to the meeting organizer. For example, the asynchronous meeting system determines whether to provide an async participant option based on one or more signals in a calendar event invite. Further, the asynchronous meeting system automatically and clearly communicates the user's intention to participate as an async participant to the meeting organizer without requiring multiple actions by the user. Additionally, the asynchronous meeting system may perform additional or different actions if the meeting organizer is utilizing a third-party system that does not fully support async participants in its calendar events.

Furthermore, the asynchronous meeting system flexibly provides various user interfaces and user experience features that facilitate async participation. For example, in various instances, the asynchronous meeting system changes the visual appearance of a calendar event for an async participant to distinguish it from other events. As another example, the asynchronous meeting system determines when to provide notifications to an async participant for the virtual meeting, including before and during the virtual meeting. The asynchronous meeting system also provides various user interface elements to indicate or signal the presence of an async participant to other meeting participants.

This disclosure uses several terms to describe the features and benefits of one or more implementations. As an example, a “virtual meeting” (or “meeting” for short) refers to a meeting conducted over a network where participants (e.g., remote participants in different geographic locations) interact using video, audio, and other collaborative tools. Usually, a meeting organizer creates the meeting via a client device and provides a calendar event invite to the client devices of potential meeting participants to join at a designated date and time through a designated application (e.g., computer application). Additionally, as an example, the term “in-person attendance” and similar terms refer to a person who participates in a virtual meeting regardless of their physical location. Thus, hybrid or virtual attendees who participate in a virtual meeting are considered to attend the meeting in person.

In some instances, a user may indicate themselves as an async participant of the virtual meeting. As an example, an “async participant” refers to a user invited to a virtual meeting who participates in the virtual meeting as a non-attending participant. While the meeting is typically a virtual meeting and is discussed as such throughout this document, in some instances, the meeting is an all in-person meeting with one or more of the users attending as an async participant.

Often, a user indicates their intention to be an async participant by selecting an async participant option presented within the calendar event invite. As an example, an “async participant option” refers to an element that signals a user as being an async participant in a virtual meeting. In many instances, selecting an async participant option will cause both frontend and backend signals to be sent to the meeting organizer and meeting participants indicating the user as an async participant. In many instances, an async participant does not attend the virtual meeting in person. In some instances, however, an async participant may attend a portion of the meeting (e.g., below a threshold duration of time) before being considered an in-person participant.

As an example, a “calendar event object” refers to a data object that includes characteristics, parameters, and information related to a calendar event. Commonly, in this document, a calendar event object includes a meeting collaborative object, which provides data regarding a virtual meeting, and an attendance collection object (or “attendance collection” for short) that lists invited participants and their meeting attendance status. Multiple applications may access a calendar event object for a virtual meeting in various instances.

As an example, a “meeting resource” refers to an artifact, document, or file that provides information associated with the meeting. For example, a meeting resource includes a meeting agenda prepared before the meeting, notes taken during the meeting, in-meeting communications such as a meeting-based chat thread, a recorded video or audio meeting session, files shared during the meeting, and/or a meeting summary. Meeting resources may be generated automatically or manually. For instance, meeting notes and/or a meeting summary with action items may be automatically generated. Additionally, in some cases, meeting resources are included within the calendar event.

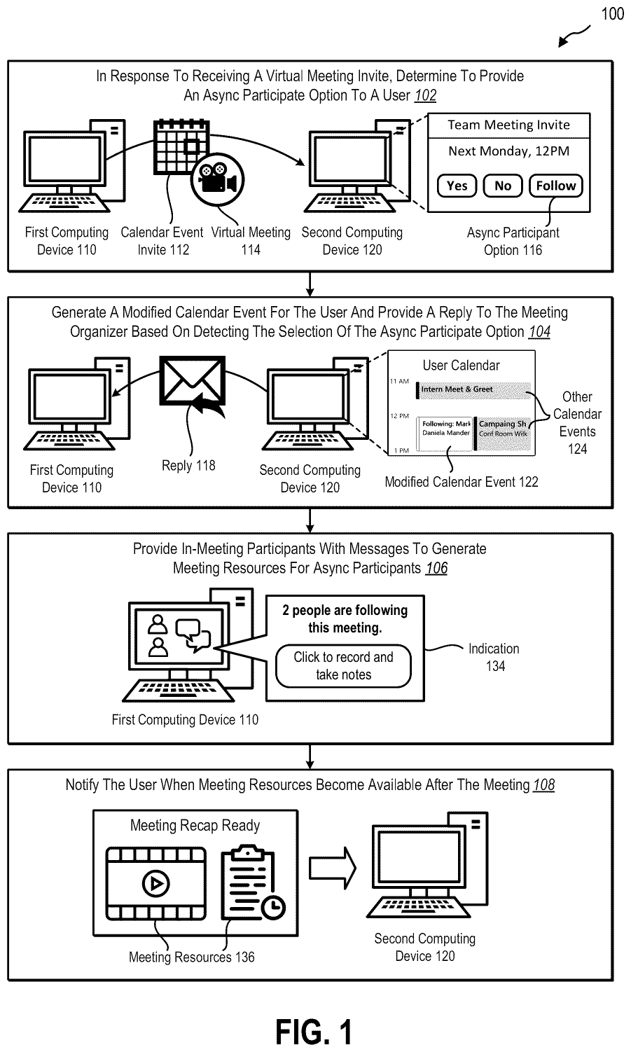

Further details regarding example implementations of the asynchronous meeting system are discussed in connection with the following figures. For example, FIG. 1 provides an overview example implementing the asynchronous meeting system to enable users to participate in virtual meetings without attending the meetings according to some implementations. As shown, FIG. 1 includes a series of acts 100 performed by the asynchronous meeting system. FIG. 1 also shows various elements, features, and components associated with the asynchronous meeting system, including a first computing device 110 associated with a meeting organizer and a second computing device 120 associated with a user (e.g., an async participant).

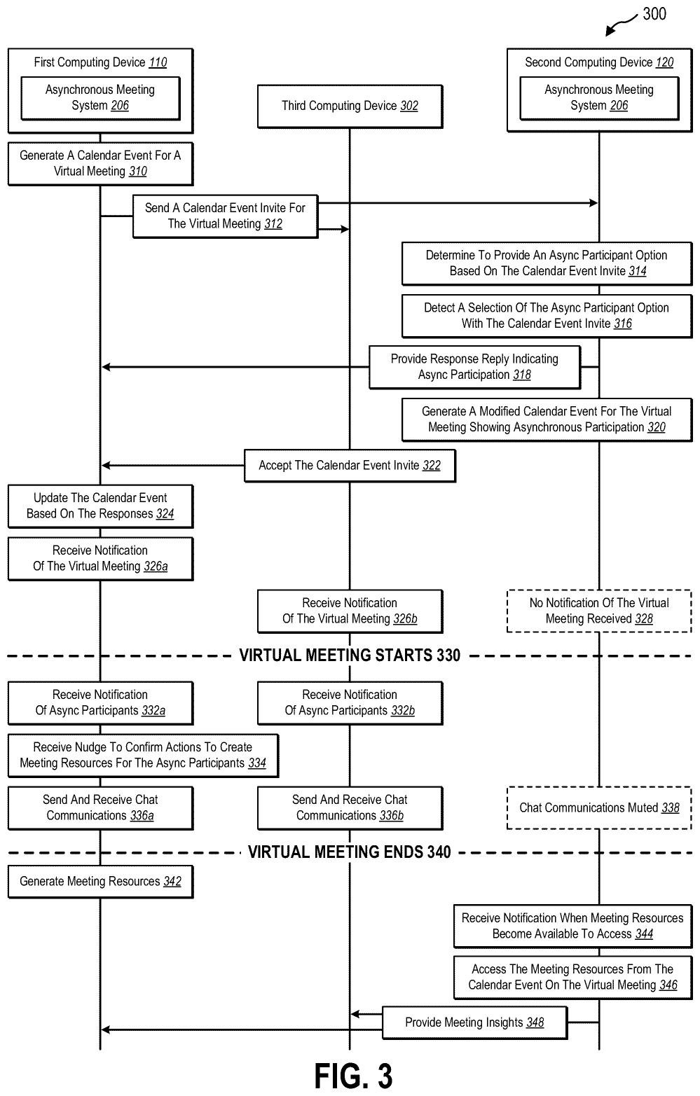

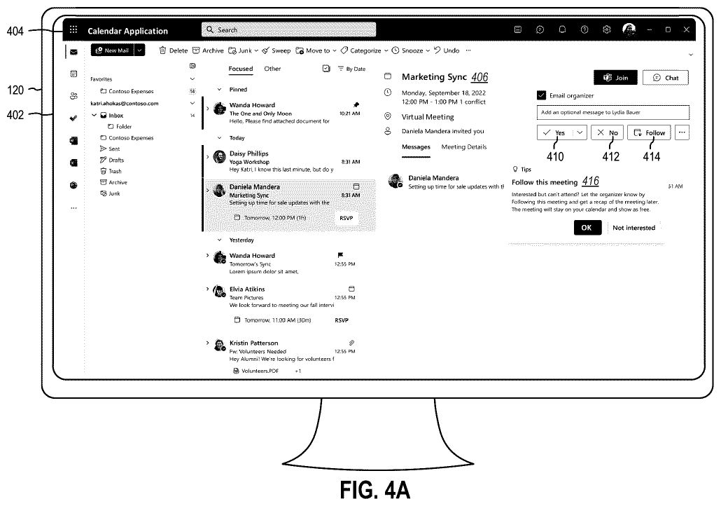

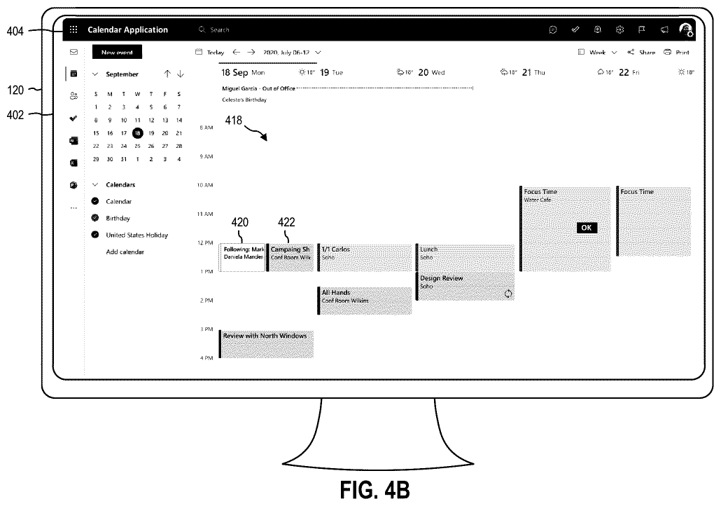

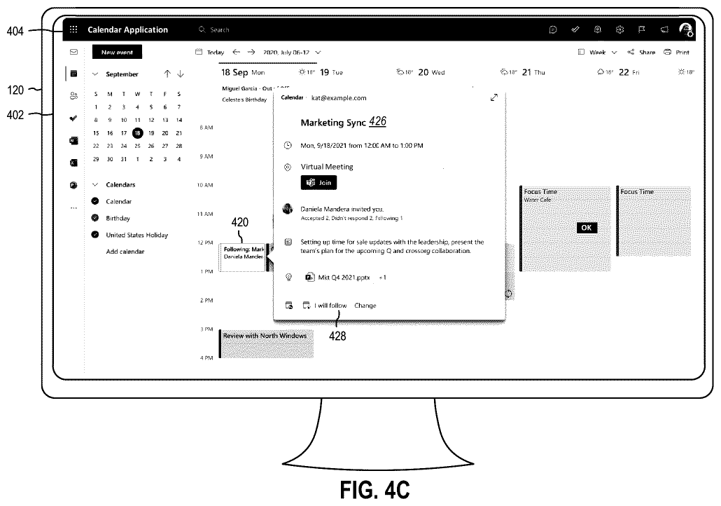

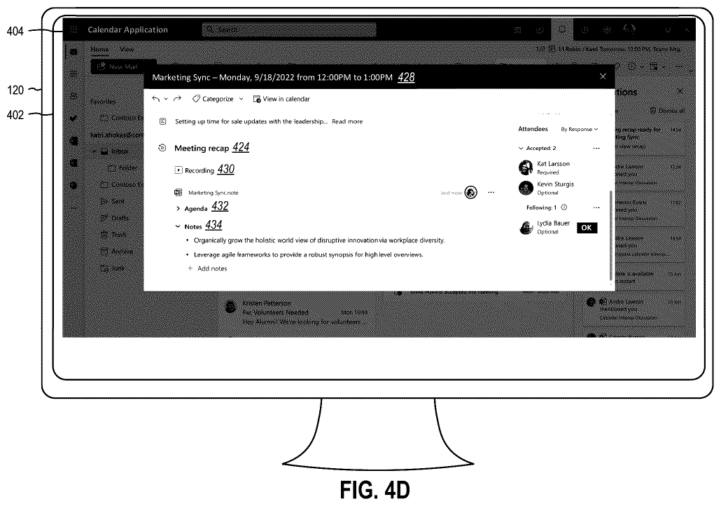

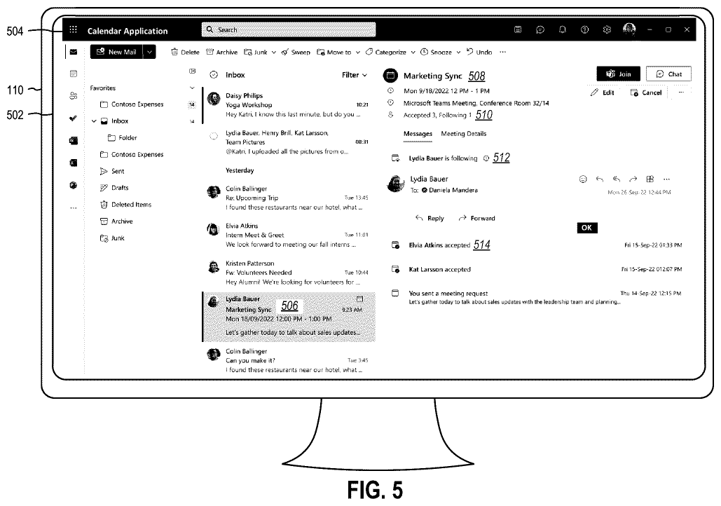

As shown in FIG. 1, the series of acts 100 in FIG. 1 includes the act 102 of determining to provide an async participant option to a user in response to receiving a virtual meeting invite. For example, in response to a meeting organizer at the first computing device 110 sending a calendar event invite 112 for a virtual meeting 114 to the second computing device 120 of a user, the asynchronous meeting system determines whether to provide the user with an async participant option 116. As described below, the asynchronous meeting system may determine whether to display the async participant option 116 based on information included in the calendar event invite 112. Additional details regarding the async participant option are provided below in connection with FIG. 3, FIG. 4A, and FIG. 5.

When the async participant option 116 is present, the asynchronous meeting system may detect a user selecting the async participant option 116 to express their intent to be an async participant. To illustrate, the series of acts 100 includes the act 104 of generating a modified calendar event for the user and providing a reply to the meeting organizer based on detecting the selection of the async participant option. For example, in response to detecting the async participant option 116 being selected, the asynchronous meeting system performs multiple actions. As one action, the asynchronous meeting system sends a reply 118 (e.g., a response message) to the second computing device 120 indicating the user is an async participant of the virtual meeting 114.

As another action, the asynchronous meeting system generates a modified calendar event 122 on the user's calendar. For example, the asynchronous meeting system generates a visually distinct calendar event for the virtual meeting that differentiates it from other calendar events 124. For instance, the asynchronous meeting system modifies the text, color, and/or background shading of the calendar event to visually indicate that the user will be an async participant. Additionally, the asynchronous meeting system may modify other characteristics of the calendar event, such as notification settings. Additional details regarding modifying the user's calendar event are provided below in connection with FIG. 3 and FIGS. 4B-4C.

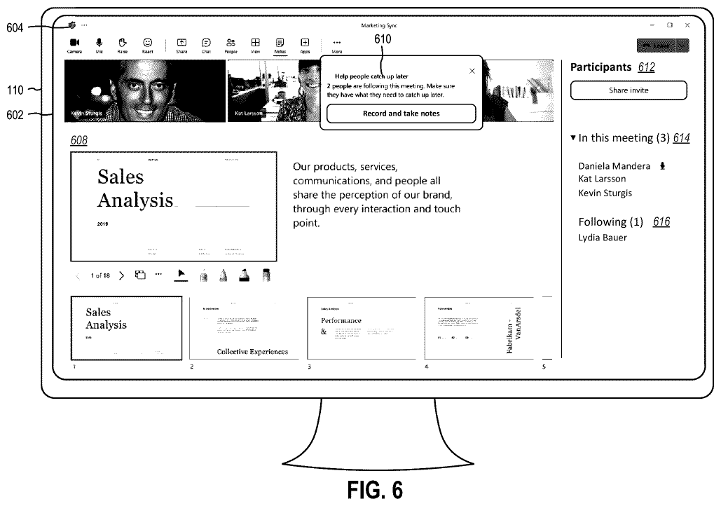

As shown, the series of acts 100 includes the act 106 of providing in-meeting participants with messages to generate meeting resources for async participants. For instance, based on the virtual meeting including an async participant, the asynchronous meeting system prompts the meeting organizer or another user with an indication 134 to generate one or more meeting resources. For example, the asynchronous meeting system prompts the meeting organizer with an option to record the meeting and/or capture notes of the meeting. Additionally, the asynchronous meeting system provides other features during the meeting to accommodate async participants. Additional details regarding the asynchronous meeting system generating meeting resources are provided below in connection with FIG. 3 and FIG. 6.

During the virtual meeting, the asynchronous meeting system may provide the async participant with access to the meeting and meeting resources as they become available. To illustrate, the act 108 shows notifying the user when meeting resources 136 become available after the meeting. For example, the asynchronous meeting system sends a message to the user when a meeting recording, action item list, or summary is available. In some implementations, meeting resources are included in the calendar event for the virtual meeting. In some instances, a message (e.g., email) with the meeting resources is sent to the async participant. Additional details regarding notifying the user of available meeting resources are provided below in connection with FIG. 3 and FIG. 4D.

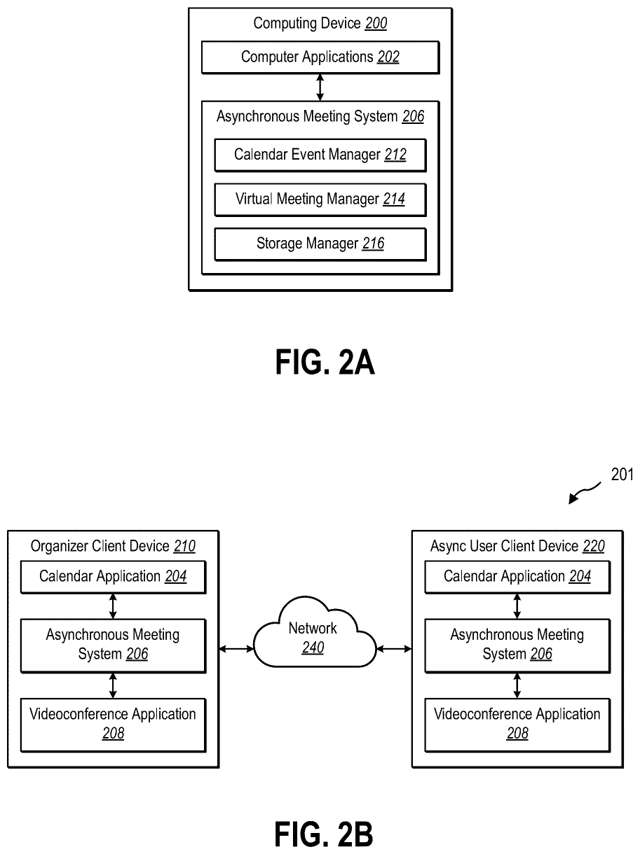

With a general overview of the asynchronous meeting system in place, additional details are provided regarding the components, features, and elements of the asynchronous meeting system. To illustrate, FIGS. 2A-2B show an example architecture and computer network environment where an asynchronous meeting system is implemented. In particular, FIG. 2A illustrates a block diagram of an example computing device that implements an asynchronous meeting system, and FIG. 2B illustrates a computer network environment where an asynchronous meeting system is implemented. While FIGS. 2A-2B show example arrangements and configurations of the asynchronous meeting system and associated components, other arrangements and configurations are possible.

As shown, FIG. 2A illustrates a block diagram of a computing device 200 that includes an asynchronous meeting system 206. In particular, the computing device 200 includes computer applications 202 and the asynchronous meeting system 206. In various implementations, the computer applications 202 represent one, two, or more applications on the computing device 200 that utilize the asynchronous meeting system 206 to provide async participation in virtual meetings.

To elaborate, the computing device 200 can represent a client device associated with a user or a server device that provides services to users. For example, the computing device 200 is part of a cloud computing system. Additionally, the computer applications 202 can correspond to various types of applications. For instance, the computer applications 202 include a videoconference application and a calendar application that coordinate, in part, via the asynchronous meeting system 206. In some implementations, the computer applications 202 include an application that combines videoconference features and calendar features. In one or more implementations, the computer applications 202 include additional or different applications.

The asynchronous meeting system 206 can include various components for enabling users to asynchronously participate in virtual meetings. For example, FIG. 2A shows that the asynchronous meeting system 206 includes a calendar event manager 212, a virtual meeting manager 214, and a storage manager 216.

In various implementations, the calendar event manager 212 enables a calendar-based application (e.g., one of the computer applications 202) to generate a calendar event that allows async participants. In addition, the calendar event manager 212 allows the calendar-based application to determine whether to include the async participant option in a calendar event invite. In response to detecting a user selecting the async participant option, the calendar event manager 212 communicates the async participant option to the meeting organizer and modifies their calendar event to indicate async participants. Furthermore, for the user (e.g., async participant), the calendar event manager 212 modifies the visual appearance and notifications of their calendar event within the calendar-based application. Additionally, the calendar event manager 212 provides additional meeting resources within or via the calendar event when available.

In one or more implementations, the virtual meeting manager 214 enables a conferencing-based application, which hosts virtual meetings, to access user data to determine when a meeting includes an async participant. When an async participant is present, the virtual meeting manager 214 enables the conferencing-based application to provide messages to meeting participants regarding the creation of meeting resources. In some instances, the virtual meeting manager 214 automatically creates one or more meeting resources, such as automatically recording the meeting or automatically generating a meeting summary. Automatically recording the meeting may by particularly useful in the case where the meeting is an all in-person meeting and it would not otherwise be recorded.

In various implementations, the storage manager 216 stores data needed by the asynchronous meeting system 206 to operate. For example, the storage manager 216 stores a calendar event object and/or portions of a calendar event object such as a meeting collaborative object or an attendee collection. In some implementations, the storage manager 216 is part of and/or accessible by the computer applications 202.

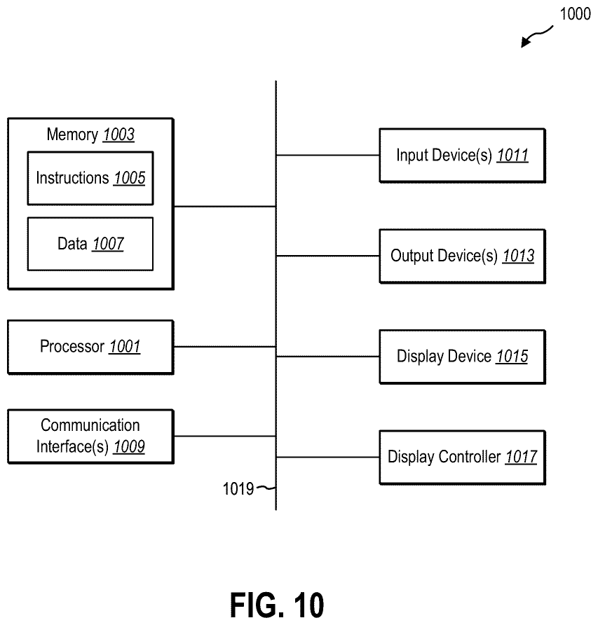

FIG. 2B illustrates a computer network environment where an asynchronous meeting system is implemented according to implementations. As shown, FIG. 2B includes a computing network environment 201 of a computing system having multiple computing devices with instances of the asynchronous meeting system 206 connected via a network 240. In particular, the computing network environment 201 includes an organizer client device 210 associated with a meeting organizer and an async user client device 220 associated with a user invited to join the virtual meeting. Further details regarding these and other computing devices are provided below in connection with FIG. 10. In addition, FIG. 10 also provides additional details regarding networks, such as the network 240 shown.

As shown, the organizer client device 210 and the async user client device 220 each include instances of a calendar application 204, the asynchronous meeting system 206, and a videoconference application 208. The organizer client device 210 includes a first instance of the asynchronous meeting system 206 that performs a first set of features for the meeting organizer, who attends the virtual meeting and the async user client device 220 includes a second instance of the asynchronous meeting system 206 that performs a second set of features for the user who is an async participant. Each instance of the asynchronous meeting system 206 may represent the asynchronous meeting system 206 described above in connection with FIG. 2A.

In various implementations, the organizer client device 210 may include the same or different computer applications as the async user client device 220. In some implementations, the calendar application 204 and the videoconference application 208 may be combined into a single computer application, as mentioned above, on one or both of the client devices. In some implementations, the calendar application 204 and the videoconference application 208 belong to the same suite of products.

In various implementations, one or both of the client devices utilize a web browser or another application to access features or services of the asynchronous meeting system 206, which is stored on a server device. Similarly, one or more of the applications on a client device may be a web-based application that interacts with the asynchronous meeting system 206 within a cloud computing system.

Turning now to FIG. 3, additional details are provided regarding the operations of the asynchronous meeting system 206 on different computing devices. In particular, FIG. 3 illustrates a sequence flow diagram enabling asynchronous participants in virtual meetings according to some implementations. FIG. 3 includes the first computing device 110 and the second computing device 120, each having an instance of the asynchronous meeting system 206 that performs operations corresponding to their respective users. In addition, FIG. 3 includes a third computing device 302, which corresponds to a user attending the virtual meeting. Furthermore, as shown, FIG. 3 includes a series of acts 300 that enable users to asynchronously participate in virtual meetings.

In FIG. 3, the series of acts 300 includes the act 310 of generating a calendar event for a virtual meeting. For example, the asynchronous meeting system 206 on the first computing device 110 enables a meeting organizer to create a virtual meeting as part of a calendar event and invite multiple participants.

In some instances, generating a calendar event results in creating a calendar event object that includes details of the event. Additionally, if the calendar event includes a virtual meeting, the calendar event object includes a meeting collaborative object (MCO) that includes meeting details (e.g., meeting date and time, link to the meeting, and invited attendees). Additionally, in some instances, the calendar event object includes an attendee collection (AC) that includes a list of the attendees and their event attendance statuses (e.g., the RSVP responses). In various instances, the MCO and the AC include similar information, which is used for different purposes.

Additionally, when the calendar event and/or calendar event object includes additional participants, the first computing device 110 generates and provides a calendar event invite (e.g., a calendar event invite invitation). To illustrate, the series of acts 300 includes the act 312 of the first computing device 110 sending a calendar event invite for the virtual meeting to the second computing device 120 and the third computing device 302. The calendar event invite may be sent to client devices associated with each invited participant.

In various implementations, the calendar event invite includes some or all of the information included in the calendar event object. For example, the calendar event invite indicates the number of invited participants with or without indicating the identities of the other invitees. In some instances, the calendar event invite includes the MCO or a version of the MCO with information about the virtual meeting.

As shown, the act 314 includes the second computing device 120 determining to provide an async participant option based on the calendar event invite. For instance, when the asynchronous meeting system 206 determines to provide the async participant option, it modifies the user interface of the calendar event invite to display an element for the async participant option. For example, the async participant option is displayed next to a positive participant option (e.g., “Yes”) and a negative participant option (e.g., “No”). An example of a graphical user interface with the async participant option is provided in FIG. 4A, which is described below.

The asynchronous meeting system 206 can determine whether to provide the async participant option based on various factors. In some instances, the asynchronous meeting system 206 determines to provide the async participant option when the virtual meeting includes three or more participants (e.g., the meeting is not a one-on-one meeting between the meeting organizer and the user). In various implementations, the asynchronous meeting system 206 determines to provide the async participant option based on identifying a signed or positive async participant flag within the calendar event invite. In these instances, the asynchronous meeting system 206 on the sender's device (e.g., the first computing device 110) or a backend server determines that the async participant option is available to the user.

In one or more implementations, the asynchronous meeting system 206 determines to provide the async participant option based on the invitation status of the user. For example, if the user is invited as an optional attendee, then the async participant option is provided. If, however, the user is a required attendee, the asynchronous meeting system 206 determines not to provide the async participant option. In one or more implementations, the asynchronous meeting system 206 determines to provide the async participant option based on another event conflicting with the virtual meeting allowing the user to follow the virtual meeting while not being able to attend the meeting.

As shown, the series of acts 100 includes the act 316 of detecting a selection of the async participant option within the calendar event invite. For example, the user selects the async participant option within the calendar event invite or via another element (e.g., clicking on the calendar event within a calendar interface). In response, the asynchronous meeting system 206 and/or the second computing device 120 detects the selection. Based on detecting the selection of the async participant option, the asynchronous meeting system 206 performs various actions. With just a single click, the asynchronous meeting system 206 automates various actions that signal to the meeting organizer, the user, and other meeting participants their intent to be an async participant.

As one action, a reply message is sent to the first computing device 110 indicating the user as an async participant, as shown in the act 318. For example, the asynchronous meeting system 206 indicates in the reply message that the user selected the async participant option. In some implementations, the reply message combines the async participant flag with another participation option (e.g., a positive participant option, a negative participant option, or a tentative participant option) to signal the user as being an async participant.

As another action, as shown in the act 320, the asynchronous meeting system 206 generates a modified calendar event for the virtual meeting to show async participation. For example, the asynchronous meeting system 206 generates a calendar event based on the calendar event invite or modifies the calendar event invite when adding it to the calendar of the user within a calendar application. This modification indicates that the user will be an async participant of the virtual meeting (e.g., the user is following the meeting).

In some instances, the asynchronous meeting system 206 modifies the calendar event for the user by changing the title of the calendar event, such as by adding additional text to the beginning or end of the title. For instance, the asynchronous meeting system 206 prepends the title or adds the prefix “Following:” to the title to indicate the user as an async participant. In some instances, if the user changes their participation status, the asynchronous meeting system 206 removes the prefix from the calendar event.

In various implementations, the asynchronous meeting system 206 modifies the visual style of the calendar event for the user by changing the color, transparency, or shading. For example, the asynchronous meeting system 206 visually distinguishes the modified calendar event from other events on the user's calendar. An example of a modified calendar event is provided in FIG. 4B, which is described below.

In one or more implementations, the asynchronous meeting system 206 modifies the calendar event for the user by marking the user as free during the virtual meeting. Typically, when a user intends to attend a virtual meeting, they are marked as busy or unavailable during the meeting time. However, when the user is an async participant, the asynchronous meeting system 206 modifies the calendar event to mark the user as free, available, or non-busy. This allows the user to be available for other overlapping events. In some instances, the calendar event is marked as free when a conflicting event is present (or later added), and otherwise, it is marked as busy.

In some implementations, the asynchronous meeting system 206 modifies the calendar event for the user by changing the notification settings. For example, the calendar event invite may include meeting notifications set by the meeting organizer such as a reminder 15 minutes before the start of the meeting. In response to detecting the selection of the async participant option, the asynchronous meeting system 206 automatically mutes or cancels reminder notifications for the virtual meeting.

In one or more implementations, the asynchronous meeting system 206 includes an async participant flag within the calendar event object of the user, which triggers the calendar application to make one or more of the modifications discussed above. For example, if the calendar application determines that an “isFollowing” property is present or positive, it applies the modifications to the calendar event.

Additionally, in various implementations, the asynchronous meeting system 206 updates the calendar event to list the user as an async participant. For example, when the calendar event is selected and additional information regarding the calendar event is displayed, the calendar event shows the number of participants according to participant type (e.g., accepted, denied, didn't respond, tentative, and/or following). In some instances, the calendar event includes the names of participants who intend to be async participants.

As shown, the series of acts 100 includes the act 322 of the third computing device 302 accepting the calendar event invite for the virtual meeting. For example, an invited participant associated with the third computing device 302 accepts the invite to the virtual meeting and provides a corresponding response.

As also shown, the series of acts 100 includes the act 324 of the first computing device 110 updating the calendar event based on the responses. For example, the first computing device 110 updates the calendar event object to indicate the user associated with the second computing device 120 as an async participant. Based on the reply from the second computing device 120, which includes an async participation signal (e.g., the selection of the async participant option or the combination of a tentative participation selection plus an async participant flag), the asynchronous meeting system 206 updates the participant status of the user as an async participant.

Additionally, the first computing device 110 may also update the calendar event object to indicate the person associated with the third computing device 302 as an attending participant. In some instances, the asynchronous meeting system 206 updates the meeting collaborative object (MCO) and/or the attendee collection (AC) with the participation statuses of invited participants as they reply.

As shown in the acts 326a and 326b, the first computing device 110 and the third computing device 302, respectively, receive notifications of the virtual meeting. For example, attending participants are notified of the virtual meeting through a reminder notification just before the meeting. Additionally, the act 328 shows that the second computing device 120 does not receive a notification of the virtual meeting. Although the user does not receive a reminder notification for the virtual meeting, they still have access to the meeting and its resources before, during, and after the meeting. In some instances, the user receives reminder notifications as an async participant.

As shown in FIG. 3 with line 330, the virtual meeting starts or begins. The asynchronous meeting system 206 may perform various actions in connection with the start of the meeting. For instance, the acts 332a and 332b show that the asynchronous meeting system 206 notifies the in-person meeting participants that the meeting includes async participants. For example, the asynchronous meeting system 206 causes a videoconferencing application to provide a notice or indication of which attendees are participating asynchronously.

In some implementations, the async participants are listed within a meeting attendance panel, window, or interface. For example, a participants panel displays the different types of participants. FIG. 6, which is described below, provides an example of a videoconferencing application with a participant panel.

In some instances, the videoconferencing application accesses the attendee collection (AC) of the calendar event object to identify participants' attendance status, such as attending, not attending, waiting to respond, and/or async participants. Additionally, in some implementations, the videoconferencing application may access the meeting collaborative object (MCO) to identify participants and their attendance status. The asynchronous meeting system 206 provides multiple applications with access to the calendar event object to ensure accuracy and efficiency across applications regarding async participants.

As shown, the series of acts 300 includes the act 334 where the first computing device 110 receives a nudge to confirm actions for creating meeting resources for async participants. For example, if an async participant flag is identified in the calendar event invite and/or MCO, or if the participant list includes an async participant, the videoconferencing application provides or sends one or more notifications to the meeting organizer via the first computing device 110.

In one or more implementations, the meeting organizer is nudged to record the meeting for the participants, especially for async participants. For example, a nudge or other reminder is provided to the meeting organizer to record an all in-person meeting where one or more users are async participants. In some instances, the meeting organizer is nudged to generate meeting documents such as a meeting transcript, notes, summary, action item list, and/or agenda. The nudge may be provided in a pop-up interface that includes selectable elements to initiate a recording, automatic note-taking, and/or generated meeting documents. In various implementations, the asynchronous meeting system 206 causes another meeting participant to be nudged if the meeting organizer is not present at the start of the virtual meeting.

In some implementations, the asynchronous meeting system 206 implements, causes, or triggers one or more actions to start automatically when an async participant is included in a meeting. For example, when the meeting organizer receives the reply message from the user indicating their intention to be an async participant, the asynchronous meeting system 206 provides options for the meeting organizer to automatically record the meeting and/or automatically take notes and generate a meeting summary. The nudges may indicate that one or more of these actions will occur automatically or prompt the meeting organizer to perform them automatically.

As shown, the series of acts 300 includes the acts 336a and 336b, where the first computing device 110 and the third computing device 302, respectively, send and receive chat communications. For example, during the virtual meeting, participants exchange messages, and they may also share documents, media, or other content outside of the videoconferencing interface. In many instances, each sharing activity triggers a notification for active participants.

As shown in the act 338, the second computing device 120 has chat communications muted due to the user being an async participant. This allows the user to access the meeting chat and other shared content at their own convenience, without being distracted by notifications for each message sent between meeting participants. This eliminates the need for the user to manually disable messages for the group.

As shown in FIG. 3 with line 340, the virtual meeting comes to an end. In response to the meeting ending, the asynchronous meeting system 206 may perform one or more additional actions related to async participants. For example, meeting resources are generated, as shown in the act 342. While the act 342 shows the first computing device 110 performing it, the asynchronous meeting system 206 and/or the videoconferencing platform or system may generate one or more meeting resources locally or via a remote computing device (e.g., on a cloud computing system).

As noted above, examples of meeting resources include meeting recordings, meeting documents, and other meeting content that are useful in memorializing the meeting. In one or more implementations, the asynchronous meeting system 206 associates meeting resources with the calendar events of the participants. The asynchronous meeting system 206 links the meeting resources with the calendar event. For example, the asynchronous meeting system 206 adds the content of some meeting resources and provides access to other meeting resources within the user's calendar event. In some instances, one or more meeting resources are emailed to the user and/or made available within the videoconferencing application.

In some instances, the asynchronous meeting system 206 provides different meeting resources to async participants than to participants attending the meeting. For example, the asynchronous meeting system 206 provides access to meeting recordings to async participants and the meeting organizer, but not to one or more other participants who attended the meeting.

As shown, the series of acts 300 includes the act 344 of the second computing device 120 receiving a notification when meeting resources become available to access. For example, depending on the availability of resources, some of the meeting resources may not be immediately accessible and/or available after the virtual meeting ends. For instance, the asynchronous meeting system 206 waits until a meeting recording, transcript, or summary is completed before sending the notification. In some instances, the asynchronous meeting system 206 waits for a predetermined time after the virtual meeting before sending the notification.

In one or more instances, the asynchronous meeting system 206 may utilize a generative language model, such as a large language model, to generate an enhanced meeting transcript or meeting summary, which may take time to complete before becoming available. In various implementations, the notification is sent via email or another messaging method.

In various implementations, the asynchronous meeting system 206 determines the priority for sending notifications to meeting participants. For example, the asynchronous meeting system 206 sends one or more notifications to the meeting organizer first, giving them the highest priority. The asynchronous meeting system 206 then prioritizes asynchronous participants over those who attended the virtual meeting. In some instances, this staggered notification approach ensures that all participants do not access the meeting resources simultaneously, allowing the hosting resources to operate more efficiently.

As mentioned earlier, in some instances, meeting resources are added to the calendar event of one or more meeting participants, including async participants. To illustrate, the act 346 shows the second computing device 120 accessing the meeting resources from the calendar event in their calendar. For example, the user opens the calendar application, locates the calendar event for the virtual meeting (which has already taken place), and selects the calendar event. The user is then provided with access to one or more meeting resources, such as a link to the meeting recording or a meeting summary. An example of a calendar application with access to meeting resources in a calendar event is shown in FIG. 4D, which is described below.

Lastly, the series of acts 300 includes the act 348 of the second computing device 120 providing meeting insights to the first computing device 110 and the third computing device 302. As an async participant, the user can contribute to the ideas and content shared in the meeting at a different time than during the actual meeting. The asynchronous meeting system 206 allows meeting participants to communicate outside of the virtual meeting, utilizing the content and resources from the meeting.

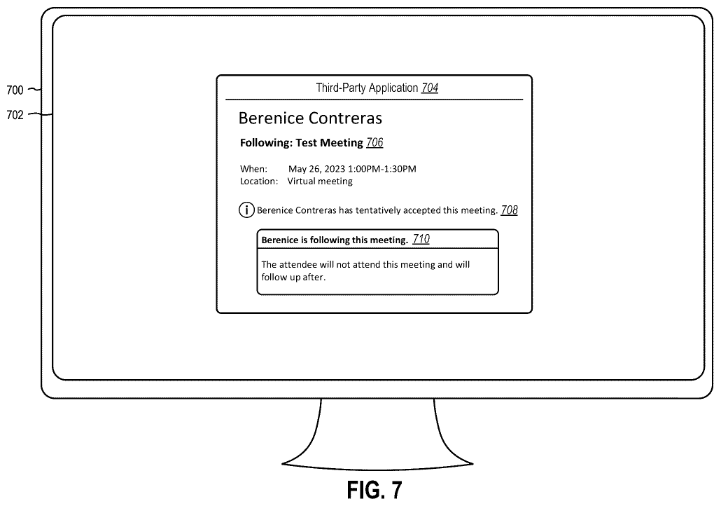

As mentioned earlier, various graphical user interface examples are provided corresponding to different implementations of the asynchronous meeting system 206. To illustrate, FIGS. 4A-4D include graphical user interfaces for an asynchronous participant participating in a virtual meeting, while FIG. 5 illustrates a graphical user interface example of a meeting organizer viewing meeting participants, including an asynchronous participant. Additionally, FIG. 6 shows a graphical user interface of an example virtual meeting that includes an asynchronous participant, and FIG. 7 displays a graphical user interface of a user communicating asynchronous participation in a virtual meeting to a third-party system. These figures involve the use of the first computing device 110 and the second computing device 120 mentioned earlier, as applicable. For clarity, callout numbers are included only in relevant parts of the figure.

FIGS. 4A-4D illustrate a sequence of graphical user interfaces for an async participant participating in a virtual meeting. These figures showcase the second computing device 120 used by a user who is invited to participate in a virtual meeting through a calendar event invite from a meeting organizer. Additionally, these figures feature include a display 402 that shows a calendar application 404 (e.g., an email application with calendar functionality) displaying various user interfaces.

Turning to FIG. 4A, in response to the second computing device 120 receiving a calendar event invite 406 for a virtual meeting, the calendar application 404 displays the invite to the user. As shown, the calendar event invite 406 includes various meeting details, which may be generated from a calendar event object, an MCO, and/or an AC.

Additionally, the calendar application 404 includes participation options, such as a positive participation option 410 confirming attendance (i.e., “Yes”), a negative participation option 412 declining attendance (i.e., “No”), and an async participant option 414 indicating async participation (i.e., “Follow”). As mentioned above, the asynchronous meeting system 206 may determine whether to display the async participant option 414 based on factors of the calendar application 404, such as the presence of three or more invited participants and/or based on an async participant option property indicating the availability of this option.

In some implementations, the async participant option 414 displaces other attendance options, such as a tentative participation option (e.g., “Tentative” or “Maybe”). In these instances, the asynchronous meeting system 206 moves these options to another menu element, such as a dropdown element.

As shown, the calendar application 404 displays a notification 416 providing information about the async participant option 414. In various implementations, the notification 416 is displayed when the calendar application 404 conflicts with another calendar event. In some instances, the asynchronous meeting system 206 causes the notification 416 to be displayed as a tooltip when the async participant option 414 is newly made available.

The user may select the async participant option 414 with a single click. This way, with minimal action, the asynchronous meeting system 206 enables the user to express their intent to be an async participant in the virtual meeting with no ambiguity to the meeting organizer or other attending participants.

Upon detecting the selection of the async participant option 414, the asynchronous meeting system 206 triggers various actions, as described above. For example, a reply message is sent to the meeting organizer indicating the user's intent to be an async participant. Additionally, the calendar application 404 may add the calendar event to the user's calendar as well as modify the calendar event to indicate async participants of the virtual meeting from other calendar events.

To illustrate, FIG. 4B shows the calendar application 404 updating to display a calendar 418 interface with calendar events. As shown, the calendar 418 includes the modified calendar event 420 for the virtual meeting and other calendar events, such as the calendar event 422. The modified calendar event 420 appears visually distinct from the other calendar events. For example, the modified calendar event 420 has “Following:” as a prefix to the calendar event title. Additionally, the background of the modified calendar event 420 is different from the calendar event 422 to signify async participation. Furthermore, the modified calendar event 420 is marked as free, indicated by the empty column on its left side (compared to the solid columns on the other calendar events, which are marked as busy).

As mentioned above, in various implementations, the calendar application 404 modifies the modified calendar event 420 based on detecting an async participant flag or property within the calendar event object for the virtual meeting. When the async participant flag is present or set to true, the calendar application 404 modifies the visual style of the modified calendar event 420.

FIG. 4C shows calendar event details 426 of the modified calendar event 420, which may be displayed upon detecting the selection of the modified calendar event 420. As shown, the calendar event details 426 display the event with the pre-pended title. Additionally, the calendar event details 426 indicate the user as an async participant 428.

FIG. 4D shows the modified calendar event 420 after the virtual meeting occurs. In particular, upon meeting resources being generated and added to the calendar event for the user, as described above, the calendar event details 426 update to include meeting resources, such as a meeting summary 424, a link to the meeting recording 430, a meeting agenda 432, and meeting notes 434. The calendar event details 426 may also indicate meeting participants, including async participants. In some implementations, the MCO indicates when meeting resources become available. This way, the user is provided with meeting resources that enable them to participate despite not attending the virtual meeting.

As mentioned above, FIG. 5 corresponds to the first computing device 110 and the meeting organizer. In particular, FIG. 5 illustrates a graphical user interface example of a meeting organizer viewing participants of the virtual meeting, including an asynchronous participant according to some implementations. FIG. 5 includes a display 502 on the first computing device 110 showing a calendar application 504 with various calendar events.

In the illustrated example, the calendar application 504 includes messages (e.g., emails), some of which correspond to calendar events. For example, the calendar application 504 shows a selected message 506 that corresponds to a calendar event 508 created by the meeting organizer and shared with invited participants (e.g., the calendar event invite). In particular, the calendar event 508 shows the current participant status of invited participants upon receiving multiple responses to the calendar event invite.

As shown, the calendar event 508 includes details about the meeting such as the meeting time, location, and a participation summary 510. The participation summary 510 lists the number of accepted participants and “following” participants (i.e., async participants). The participation summary 510 may also include declined or tentative participants.

The calendar event 508 may also include messages and other meeting details. As shown, a first message 512 indicates that a user has responded to the calendar event invite as an async participant. A second message 514 indicates another invited participant accepting the calendar event invite.

In various implementations, the calendar event 508 is populated based on information from a calendar event object. For instance, when responses from invited participants are received, the asynchronous meeting system 206 updates the meeting collaborative object (MCO) and/or the attendee collection (AC). For example, the participation summary 510 is obtained from the participants and their attendance status as listed in the AC of the calendar event object.

FIG. 6 illustrates a graphical user interface example of a virtual meeting that includes an asynchronous participant according to some implementations. As shown, FIG. 6 includes the first computing device 110 of the meeting organizer, which includes a display 602 and a videoconferencing application 604. As also shown, the videoconferencing application 604 includes a videoconference interface 608 that implements the virtual meeting.

Additionally, the videoconferencing application 604 includes a participant list 612 that displays the invited participants and their attendance status. For example, the participant list 612 lists attending participants 614 who are present in the meeting and async participants 616 who are not attending the meeting but participating in other ways. In various instances, the participant list 612 is derived from the participants and their attendance status as listed in the AC of the calendar event object. In some implementations, the participant list 612 utilizes a different section of the calendar event object or another data object to list the participants of the virtual meeting.

As mentioned above, the asynchronous meeting system 206 may provide or send nudges or notifications to the meeting organizer (or another user in their absence) regarding the creation of meeting resources to accommodate async participants. For example, when an async participant is identified within the list of meeting participants (e.g., from the MCO or AC), the videoconferencing application 604 triggers one or more actions to generate meeting resources for the async participants.

To illustrate, the videoconferencing application 604 includes an async participant notification 610 that appears at the beginning of the meeting, prompting the meeting organizer to initiate (or confirm) the recording and/or creation of meeting notes for the virtual meeting. This way, the asynchronous meeting system 206 ensures that meeting resources are generated to accommodate the async participants.

FIG. 7 illustrates a graphical user interface example of a user communicating asynchronous participation in a virtual meeting to a third-party system according to some implementations. FIG. 7 includes a client device 700 corresponding to a meeting organizer that utilizes a third-party system to create and send a meeting invite (e.g., a calendar event invite) to multiple invitees.

As shown, the client device 700 includes a display 702 that shows a third-party application 704. The third-party application 704 displays a reply message 706 from an invited participant who is not using the third-party system. Additionally, the reply message 706 indicates that the invited participant replied or responded to the calendar event invite by selecting an async participant option, which may not be recognized by the third-party system.

In one or more implementations, the asynchronous meeting system 206 determines that a calendar event invite for a virtual meeting is from a third-party system. In some implementations, the asynchronous meeting system 206 may change or modify the reply message when the async participant option is selected. For example, the asynchronous meeting system 206 selects a tentative participation option and automatically includes a reply message to the meeting organizer, indicating that the invited participant desires to be an async participant in the virtual meeting. In some instances, the asynchronous meeting system 206 also modifies the subject of the calendar event invite in the reply by adding a prefix that indicates the invited participant's status as an async participant.

Additionally, the asynchronous meeting system 206 may also include the async participant flag in the reply message, although it may or may not be correctly read or interpreted by the third-party system. In various implementations, the asynchronous meeting system 206 performs these actions for internally generated calendar event invites.

As shown, the reply message 706 indicates that the invited participant responded with the tentative acceptance option 708. Furthermore, the reply message 706 includes the automated async participant message 710, which conveys the invited participant's intention to participate in the meeting without attending it. This way, the asynchronous meeting system 206 enables users to signal or express their intent to be an async participant regardless of the system that generates the calendar event invite.

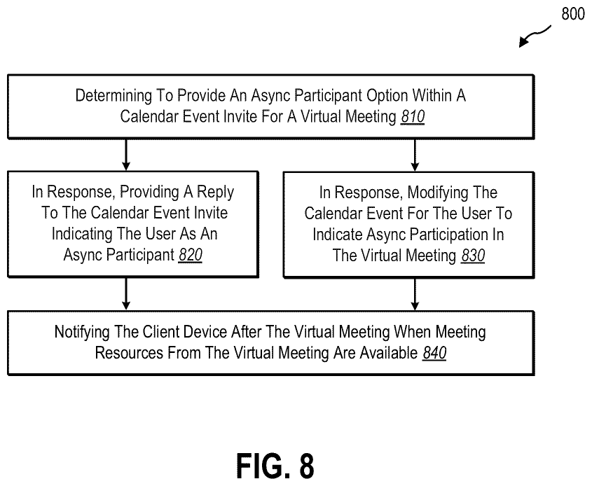

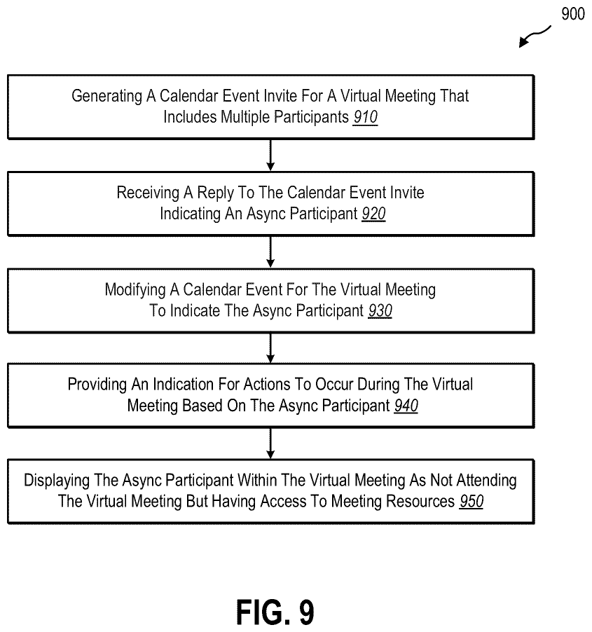

Turning now to FIG. 8 and FIG. 9, these figures illustrate flowcharts that include two example series of acts for utilizing the asynchronous meeting system 206 according to some implementations. In particular, FIG. 8 and FIG. 9 each illustrate a series of acts of computer-implemented methods for implementing asynchronous user participation across multiple computer applications.

While FIG. 8 and FIG. 9 each illustrate acts according to one or more implementations, alternative implementations may omit, add, reorder, and/or modify any of the acts shown. Further, the acts of FIG. 8 and FIG. 9 can each be performed as part of a method such as a computer-implemented method. Alternatively, a non-transitory computer-readable medium can include instructions that, when executed by a processor, cause a computing device to perform the acts of FIG. 8 and FIG. 9.

As shown, the series of acts 800 includes an act 810 of determining to provide an async participant option within a calendar event invite for a virtual meeting. For example, the act 810 involves determining to provide the async participant option within a calendar event invite based on receiving the calendar event invite for a virtual meeting at a client device associated with a user. In some instances, the act 810 involves determining to provide an async participant option within a calendar event invite for a virtual meeting received by or sent to a client device associated with a user. In one or more implementations, the act 810 includes determining to provide an async participant option within a calendar event invite based on receiving the calendar event invite for a virtual meeting at a client device associated with a user within a first application.

In various implementations, the act 810 includes determining to provide the async participant option within the calendar event invite by determining that of checking if the calendar event invite includes three or more (i.e., more than two) meeting participants, determining that the calendar event invite includes an async participant flag positively indicating an availability of the async participant option (e.g., verifying the presence of an asynchronous participant flag indicating the availability of the asynchronous participant option), and/or displaying the async participant option within the calendar event invite along with a positive participant option and a negative participant option.

As further shown, the series of acts 800 includes an act 820 of providing a reply to the calendar event invite indicating the user as an async participant in response to detecting a selection of the async participant option. For instance, in example implementations, the act 820 involves, in response to detecting a selection of the async participant option, providing a reply to the calendar event invite indicating the user as an async participant of the virtual meeting. In one or more implementations, the act 820 includes providing a reply to the calendar event invite indicating the user as an async participant of the virtual meeting in response to detecting a selection of the async participant option within the first application.

In some implementations, the act 820 includes generating a reply message that includes the selection of a positive participant option, a negative participant option, or a tentative participant option combined with an async participant flag. In one or more implementations, the act 820 of providing the reply to the calendar event invite indicating the user as an async participant of the virtual meeting causes a calendar event object for the virtual meeting to be modified to indicate the user as an async participant. In various instances, a video-conference application prompts a participant attending the virtual meeting to perform one or more actions based on the calendar event object indicating the user as an async participant.

As further shown, the series of acts 800 includes an act 830 of modifying the calendar event for the user to indicate async participation in the virtual meeting in response to detecting a selection of the async participant option. For instance, in example implementations, the act 830 involves, in response to detecting a selection of the async participant option, modifying a calendar event for the user displayed on the client device to indicate async participation in the virtual meeting. In some instances, the calendar event has different visual styles and/or properties from other calendar events of the user. In one or more implementations, the act 830 includes in response to detecting a selection of the async participant option within the first application modifying a calendar event within the first application for the user displayed on the client device to indicate async participation in the virtual meeting.

In some implementations, the calendar event has different visual properties from other calendar events of the user. In various implementations, the act 830 includes adding a prefix to the title of the calendar event indicating the async participant option. In one or more implementations, the act 830 includes modifying the visual appearance of the calendar event to a different color, transparency, or shade than the other non-async calendar events of the user from the same calendar. In some instances, the calendar event is also modified by including the user as an async participant of the virtual meeting, which is different from an attending participant and a non-attending participant, muting reminder notifications of the calendar event, and/or setting the user status as available. In various instances, the act 830 causes a calendar event object for the virtual meeting to be modified to indicate the user as an async participant. In some instances, multiple computer applications access the same calendar event object to show the user as an async participant.

As further shown, the series of acts 800 includes an act 840 of notifying the client device after the virtual meeting when meeting resources from the virtual meeting are available. For instance, in example implementations, the act 840 involves notifying the client device after the virtual meeting occurs when meeting resources created from the virtual meeting have been added to the calendar event displayed on the client device. In one or more implementations, the act 840 includes notifying the client device when meeting resources created from the virtual meeting have been added to the calendar event displayed on the client device after the virtual meeting occurs in a second application.

In various implementations, the act 840 is based on the user being an async participant of the virtual meeting. In one or more implementations, the meeting resources created from the virtual meeting, which are added to the calendar event of the user, include meeting notes, a meeting summary, or access to a meeting recording. In some implementations, a video-conference application prompts a participant attending the virtual meeting to perform one or more actions based on the calendar event object indicating the user as an async participant.

In some instances, the act 840 includes providing, at the client device, the user with access to communications from other meeting participants occurring during the virtual meeting, at the client device, and/or muting notifications (e.g., reminder notifications) of the communications from the other meeting participants occurring during the virtual meeting.

In some implementations, the series of acts 800 includes additional acts. For example, the series of acts 800 includes detecting an additional selection of a positive participant option or a negative participant option within the calendar event before the virtual meeting and removing the modifications to the calendar event indicating the user as the async participant. In some implementations, when the computer applications access information from the calendar event object, the first application is a calendar application and the second application is a video-conferencing application. In other instances, the first application is a calendar application and the second application are the same video-conferencing application (i.e., the same computer application).

In some implementations, the calendar event invite is provided by a third-party communication system that does not support async participants, and providing the reply to the calendar event invite indicating the user as an async participant of the virtual meeting includes indicating the user as a participant type supported by the third-party communication system and/or automatically populating the reply to indicate that the user intends to join the virtual meeting as an async participant.

As mentioned above, FIG. 9 illustrates a series of acts 900 of a computer-implemented method for implementing asynchronous user participation across multiple computer applications.

As shown, the series of acts 900 includes an act 910 of generating a calendar event invite for a virtual meeting that includes multiple participants. For example, the act 910 involves generating a calendar event invite for a virtual meeting that includes at least three participants at a first client device associated with a meeting organizer.

As further shown, the series of acts 900 includes an act 920 of receiving a reply to the calendar event invite indicating an async participant. For instance, in example implementations, the act 920 involves receiving, from a second client device associated with a participant of the at least three participants, a reply to the calendar event invite indicating the participant as an async participant.

As further shown, the series of acts 900 includes an act 930 of modifying a calendar event for the virtual meeting to indicate the async participant. For instance, in example implementations, the act 930 involves modifying a calendar event for the virtual meeting displayed on the first client device to indicate the participant as an async participant.

As further shown, the series of acts 900 includes an act 940 of providing an indication for actions to occur during the virtual meeting based on the async participant. For instance, in example implementations, the act 940 involves providing an indication to the first client device for one or more actions to occur during the virtual meeting based on the calendar event indicating the participant as an async participant. In various implementations, the act 940 includes starting a recording of the virtual meeting to be provided to one or more async participants, providing a first message for the virtual meeting to be recorded for the one or more async participants, and/or providing a second message for virtual meeting notes to be captured for the one or more async participants.

As further shown, the series of acts 900 includes an act 950 of displaying the async participant within the virtual meeting as not attending the virtual meeting but having access to meeting resources. For instance, in example implementations, the act 950 involves displaying, within the virtual meeting, the participant as an async participant that has access to meeting resources but that is not attending the virtual meeting based on the calendar event indicating the participant as an async participant.

FIG. 10 illustrates certain components that may be included within a computer system 1000 that implements the asynchronous meeting system 206. The computer system 1000 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 1000 represents one or more of the client devices, server devices, or other computing devices described above. For example, the computer system 1000 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1000 includes a processing system including a processor 1001. The processor 1001 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1001 may be referred to as a central processing unit (CPU) and may cause computer-implemented instructions to be performed. Although the processor 1001 shown is just a single processor in the computer system 1000 of FIG. 10, in an alternative configuration, a combination of processors (e.g., an ARM and DSP) could be used.

The computer system 1000 also includes memory 1003 in electronic communication with the processor 1001. The memory 1003 may be any electronic component capable of storing electronic information. For example, the memory 1003 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1005 and the data 1007 may be stored in the memory 1003. The instructions 1005 may be executable by the processor 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during the execution of the instructions 1005 by the processor 1001.

A computer system 1000 may also include one or more communication interface(s) 1009 for communicating with other electronic devices. The one or more communication interface(s) 1009 may be based on wired communication technology, wireless communication technology, or both. Some examples of the one or more communication interface(s) 1009 include a Universal Serial Bus (USB), an Ethernet adapter, a wireless adapter that operates according to an Institute of Electrical and Electronics Engineers (IEEE) 1002.11 wireless communication protocol, a Bluetooth® wireless communication adapter, and an infrared (IR) communication port.

A computer system 1000 may also include one or more input device(s) 1011 and one or more output device(s) 1013. Some examples of the one or more input device(s) 1011 include a keyboard, mouse, microphone, remote control device, button, joystick, trackball, touchpad, and light pen. Some examples of the one or more output device(s) 1013 include a speaker and a printer. A specific type of output device that is typically included in a computer system 1000 is a display device 1015. The display device 1015 used with implementations disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For clarity, the various buses are illustrated in FIG. 10 as a bus system 1019.

This disclosure describes an asynchronous meeting system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for implementing asynchronous user participation across multiple computer applications, comprising:
determining to provide an async participant option within a calendar event invite for a virtual meeting received by a client device associated with a user;
in response to detecting a selection of the async participant option:
providing a reply to the calendar event invite indicating the user as an async participant of the virtual meeting; and
modifying a calendar event for the user displayed on the client device to indicate async participation in the virtual meeting, wherein the calendar event has different visual properties from other calendar events of the user; and
after the virtual meeting occurs, notifying the client device when meeting resources created from the virtual meeting have been added to the calendar event displayed on the client device.

2. The computer-implemented method of claim 1, wherein determining to provide the async participant option within the calendar event invite includes:
determining that the calendar event invite includes three or more meeting participants; and
enabling display of the async participant option within the calendar event invite in connection with a positive participant option and a negative participant option.

3. The computer-implemented method of claim 1, wherein modifying the calendar event for the user indicating async participation in the virtual meeting includes adding a prefix to a title of the calendar event indicating the async participant option.

4. The computer-implemented method of claim 1, wherein modifying the calendar event for the user indicating async participation in the virtual meeting includes modifying a visual appearance of the calendar event to a different color, transparency, or shade than the other non-async calendar events of the user from a same calendar.

5. The computer-implemented method of claim 1, further comprising, in response to detecting the selection of the async participant option, further modifying the calendar event by:
including the user as an async participant of the virtual meeting using a different indication than indications used to indicate an attending participant and a non-attending participant;
muting reminder notifications of the calendar event; and
setting a user status as available.

6. The computer-implemented method of claim 1, wherein determining to provide the async participant option within the calendar event invite includes:
determining that the calendar event invite includes an async participant flag positively indicating an availability of the async participant option; and
enabling display the async participant option within the calendar event invite in connection with a positive participant option and a negative participant option.

7. The computer-implemented method of claim 1, wherein providing the reply to the calendar event invite indicating the user as an async participant of the virtual meeting includes generating a reply message that includes a selection of a positive participant option, a negative participant option, or a tentative participant option combined with an async participant flag.

8. The computer-implemented method of claim 1, further comprising:
providing, at the client device, the user with access to communications from other meeting participants occurring during the virtual meeting; and
muting notifications at the client device of the communications from the other meeting participants occurring during the virtual meeting.

9. The computer-implemented method of claim 1, wherein notifying the client device when the meeting resources created from the virtual meeting have been added to the calendar event is based on the user being an async participant of the virtual meeting.

10. The computer-implemented method of claim 1, wherein the meeting resources created from the virtual meeting that are added to the calendar event of the user include meeting notes, a meeting summary, or access to a meeting recording.

11. The computer-implemented method of claim 1, wherein providing the reply to the calendar event invite indicating the user as an async participant of the virtual meeting causes a calendar event object for the virtual meeting to be modified to indicate the user as an async participant, wherein multiple computer applications access the calendar event object to show the user as an async participant.

12. The computer-implemented method of claim 1, further comprising:
detecting, before the virtual meeting, an additional selection of a positive participant option or a negative participant option within the calendar event; and
removing modifications to the calendar event indicating the user as the async participant.

13. A system for implementing asynchronous user participation across multiple computer applications, comprising:
a processing system comprising a processor; and
a computer memory comprising instructions that, when executed by the processing system, cause the system to perform operations comprising:
determining to provide an async participant option within a calendar event invite based on receiving the calendar event invite for a virtual meeting at a client device associated with a user within a first application;
in response to detecting a selection of the async participant option within the first application:
providing a reply to the calendar event invite indicating the user as an async participant of the virtual meeting; and
modifying a calendar event within the first application for the user displayed on the client device to indicate async participation in the virtual meeting, wherein the calendar event has different visual properties from other calendar events of the user; and
after the virtual meeting occurs in a second application, notifying the client device when meeting resources created from the virtual meeting have been added to the calendar event displayed on the client device.

14. The system of claim 13, wherein the first application is a calendar application and the second application is a video-conferencing application.

15. The system of claim 13, wherein both the first application is a calendar application and the second application are a same video-conferencing application.

16. The system of claim 13, wherein providing the reply to the calendar event invite indicating the user as an async participant of the virtual meeting causes a calendar event object for the virtual meeting to be modified to indicate the user as an async participant, wherein a video-conference application prompts a participant attending the virtual meeting to perform one or more actions based on the calendar event object indicating the user as an async participant.

17. The system of claim 13, wherein the operations also include muting, at the client device, notifications from communications from other meeting participants occurring during the virtual meeting.

18. The system of claim 13, wherein:
the calendar event invite is provided by a third-party communication system that does not support async participants; and
providing the reply to the calendar event invite indicating the user as an async participant of the virtual meeting includes:
indicating the user as a participant type supported by the third-party communication system; and
automatically populating the reply to indicate that the user intends to join the virtual meeting as an async participant.

19. A computer-implemented method for implementing asynchronous user participation across multiple computer applications, comprising:
generating, at a first client device associated with a meeting organizer, a calendar event invite for a virtual meeting that includes at least three participants;
receiving, from a second client device associated with a participant of the at least three participants, a reply to the calendar event invite indicating the participant as an async participant;
modifying an organizer calendar event for the virtual meeting displayed on the first client device to indicate the participant as an async participant; and
based on the organizer calendar event indicating the participant as an async participant:
providing an indication to the first client device for one or more actions to occur during the virtual meeting; and
enabling display within the virtual meeting, the participant as an async participant that has access to meeting resources but that is not attending the virtual meeting.

20. The computer-implemented method of claim 19, wherein providing the indication to the first client device includes:
starting a recording of the virtual meeting to be provided to one or more async participants;
providing a first message for the virtual meeting to be recorded for the one or more async participants; or
providing a second message for virtual meeting notes to be captured for the one or more async participants.
